(19) United States
(12) Patent Application Publication
(10) Pub. No.: US 2026/0147987 A1
(43) Pub. Date: May 28, 2026

(54) TRAINING A REDACTION MODEL TO REDACT INFORMATION FROM FORMS

(71) Applicant: Intuit Inc., Mountain View, CA (US)

(72) Inventors: Kaunil DHRUV, San Jose, CA (US); Guohan GAO, San Jose, CA (US)

(21) Appl. No.: 18/961,349

(22) Filed: Nov. 26, 2024

(51) Int. Cl. G06F 40/174; G06N 3/0475

(52) U.S. Cl. CPC G06F 40/174; G06N 3/0475

(57) ABSTRACT

Certain aspects of the disclosure provide a method for training a machine learning redaction model. The method includes: generating a filled form, wherein one or more locations are associated with one or more bounding boxes; transforming the filled form into one or more transformed filled forms associated with one or more respective transformed bounding boxes; training the machine learning redaction model based on the one or more transformed filled forms, the training comprising: providing the one or more transformed filled forms as input into the machine learning redaction model; receiving one or more redacted forms as output from the machine learning redaction model, adjusting one or more parameters of the machine learning redaction model based on the one or more transformed filled forms, the one or more redacted forms, and one or more loss functions.

### BACKGROUND

### Field

Aspects of the present disclosure relate to training a machine learning model to redact information from forms.

### Description of Related Art

Forms may include a variety of different types of information. For example, forms may include information about an individual that may be useful for providing services for the individual. In an example, a form may include medical information about an individual that can be used to provide a health assessment to the individual. In another example, a form may include financial information for an individual that can be used to prepare tax documents for the individual.

In order to provide services based on information contained in a form, the information may need to be obtained (e.g., pulled or extracted) from the form. As information may need to be obtained from a large number of forms, such as for a large number of different users, it may be useful to automate the process of obtaining information from forms, as manual extraction of information may not be feasible at a large scale.

Automating obtaining information from forms may present certain challenges. Often there may be different formats of forms (e.g., that correspond to different templates) that include the same type of information, as different organizations may utilize different formats of forms. Creating tools that can automatically obtain information from many different formats of forms may be challenging, due to the potential large number of variances that may need to be accounted for between forms.

In some cases, it may be useful to obtain forms, such as from individuals, that include information about the individuals. In particular, it may be useful to utilize such forms as samples to develop tools for automatically obtaining information from forms. For example, the representations of forms obtained from individuals may be obtained in a variety of different conditions, such as imperfect images of the forms (e.g., wrinkled, discolored, misaligned, poor lighting, etc.). Utilizing such variations in forms for developing tools for automatically obtaining information from forms may help make the tools more robust in being able to obtain information even from forms that are imperfectly captured (e.g., imaged).

However, such forms may include information that is sensitive, or should not be otherwise widely distributed. For example, the forms may include personal identifying information (PII). Examples of PII may include a full name, social security number (SSN), date of birth, address, phone number, email address, driver's license number, passport number, financial information, or medical information. In some cases, such as for privacy, such information should not be included in samples used for developing tools for forms, such as tools for automatically obtaining information from forms.

As a result, there is a need for techniques for removing or redacting information (e.g., sensitive information, such as PII) from forms.

### SUMMARY

Certain aspects provide a method for training a machine learning redaction model. The method includes: generating a filled form comprising inserting dummy data into one or more locations of a template form, wherein the one or more locations are associated with one or more bounding boxes; transforming the filled form, associated with the one or more bounding boxes, into one or more transformed filled forms, each of the one or more transformed filled forms associated with one or more respective transformed bounding boxes; training the machine learning redaction model based on the one or more transformed filled forms, the training comprising: providing the one or more transformed filled forms as input into the machine learning redaction model; receiving one or more redacted forms as output from the machine learning redaction model, based on the one or more transformed filled forms, the one or more redacted forms corresponding to the one or more transformed filled forms; and adjusting one or more parameters of the machine learning redaction model based on the one or more transformed filled forms, the one or more redacted forms, and one or more loss functions.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system for generating training data and training a machine learning redaction model based on the training data.

FIG. 2 depicts an example system for transforming forms, such as for use as training data.

FIG. 3 depicts an example template form with bounding boxes.

FIG. 4 depicts an example transformer output, bounding box, and redacted form.

FIG. 5 depicts an example system for generating redacted forms and training a machine learning model based on the redacted forms.

FIG. 6 depicts an example method for training a machine learning redaction model.

FIG. 7 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for training a machine learning redaction model to redact information from forms. A machine learning redaction model may be a machine learning model configured to redact (e.g., remove, erase, etc.) information from an image or other representation, such as of a form.

In certain aspects, conventional machine learning redaction models (e.g., a scene text eraser model, where an image of a scene is partitioned into smaller sections that are erased section-by-section without detecting specific text) may be well suited for certain tasks, such as removing all text from an image. However, such conventional machine learning redaction models may not be well suited to redacting certain information, such as PII, from a form. For example, conventional machine learning redaction models may remove more information from a form (e.g., in addition to PII) than may be needed, may fail to remove certain information from a form, or may fail to fill in the area of the form where the information is removed in a suitable manner, such as with a background that reflects the background of the overall form itself. Accordingly, there is a technical problem with respect to how to redact information from forms automatically.

Certain aspects herein provide a technical solution to the technical problem of how to redact information from forms automatically, such as by providing techniques for training a machine learning redaction model to redact information from forms. For example, certain aspects provide techniques for generating training data comprising forms and training a machine learning redaction model to redact information from forms based on the generated training data. In certain aspects, such training of a machine learning redaction model using such training data may provide the technical effect of generating a trained machine learning redaction model that is capable of more accurately redacting information from forms.

In certain aspects, the training data includes forms filled with dummy data. Dummy data may include fictitious (e.g., synthetic) data, such as names, addresses, other PII, etc., that is not for an actual individual. In certain aspects the dummy data may be obtained from a public source of dummy data, or may be generated. Utilizing forms filled with dummy data for training may have the technical effect of accurately training the machine learning redaction model for forms, while avoiding using actual information (e.g., PII) to train the model, thereby avoiding privacy issues.

In certain aspects, to generate a given form filled with dummy data, a template form may be obtained. A template form may be a blank form that has no individual information filled in the form. The template form may include one or more locations (e.g., fields) where an individual can fill information. In certain aspects, a bounding box is generated for each of the one or more locations. In certain aspects, a bounding box is a (e.g., rectangular) border that is used to define the position and dimensions of an object (e.g., location, such as a field) within an image or document, such as corresponding to a form. For example, a bounding box may be defined as one or more coordinates, dimensions, and/or the like. In the context of machine learning, bounding boxes may be employed to specify the areas that contain relevant information. For example, in a filled form, bounding boxes can be used to delineate the locations that may include certain information, such as PII. These bounding boxes may help the machine learning redaction model accurately identify and focus on the specific regions that need to be redacted, thereby improving the precision and effectiveness of the redaction.

In certain aspects, dummy data is automatically inserted into the template form, such as at the location(s) of the bounding box(es). Accordingly, a filled form is generated that includes dummy data. In certain aspects, the filled form is transformed, to generate one or more transformed forms. For example, one or more transformations, such as skew, color adjustment, application of a texture, etc., may be applied to the filled form to generate a transformed form. Such a transformed form may be generated to better resemble a possible representation of a form that may be received from an individual. In particular, an individual may typically capture an image of a form using a phone camera, and the form may be wrinkled, have poor lighting, be captured at an odd angle, etc. Accordingly, the transformed form may better represent a real world form. The machine learning redaction model may be trained on one or more such transformed forms. Training the machine learning redaction model on transformed form(s) may provide the technical effect of accurately training the machine learning redaction model for redacting information from actual user forms which may have a number of issues in how they are represented, and not look just like ideal template forms, as discussed.

In certain aspects, one or more loss functions may be used for training the machine learning redaction model, such as to adjust parameters (e.g., weights) of the model. A loss function may be a mathematical function that quantifies error between a model's predicted output and a target output. In certain aspects, the model's predicted output is a redacted form generated from a transformed form. In certain aspects, the target output may also be generated similar to the transformed form. For example, as discussed, the transformed form may be made from a fully filled form, which may be generated by filling all fields of a template form. The same template form may be used to generate a partially filled form, which may be generated by filling a subset of fields of the template form. In particular, the subset of fields of the template form may be fields that typically do not include PII, while the remaining fields of the template form may typically include PII to be redacted. The partially filled form, or the template form itself if all fields may typically include PII to be redacted, may be transformed to generate the target output, using the same transformation as used to generate the transformed form. Accordingly, the target output may represent the transformed form, with the appropriate text not included (e.g., redacted) from the form. In certain aspects, the target output may be the transformed form itself used as input to the machine learning redaction model, such as to ensure visual similarity between the transformed form and the predicted output.

In certain aspects, the one or more loss functions may include continuity loss, which measures the degree to which text redaction may be detected in the predicted output form. After redacting text based on the transformed filled form and the bounding box, the model may insert a background image in the space where the text was redacted to make the redaction less detectable. In certain aspects, a similarity of the background replacement image pixels along the edges of the redacted area to the pixels of the form surrounding the redacted area may be calculated and expressed as the continuity loss. A technical benefit of the continuity loss may be that a background image inserted to replace the redacted text may better resemble the actual form, thereby creating more accurate training data.

In certain aspects, the one or more loss functions may include a dice score, which measures similarity between two images, in this case the target output form and the predicted output redacted form. A technical benefit of the dice score is improved quality of the redacted form to resemble the actual form. In certain aspects, the one or more loss functions may include reconstruction loss, which measures the effectiveness of redaction by calculating a score based on a pixel-by-pixel comparison of the target output form to the redacted form. A technical benefit of the reconstruction loss is that the bounding box is also taken into account in the calculation to more accurately reflect the redaction process. The one or more loss functions may be used to adjust parameters of the machine learning redaction model such that the effectiveness of the redaction model may be improved iteratively as more training data, e.g., transformed filled forms, may be provided to the machine learning redaction model.

### Example System for Training the Redaction Model

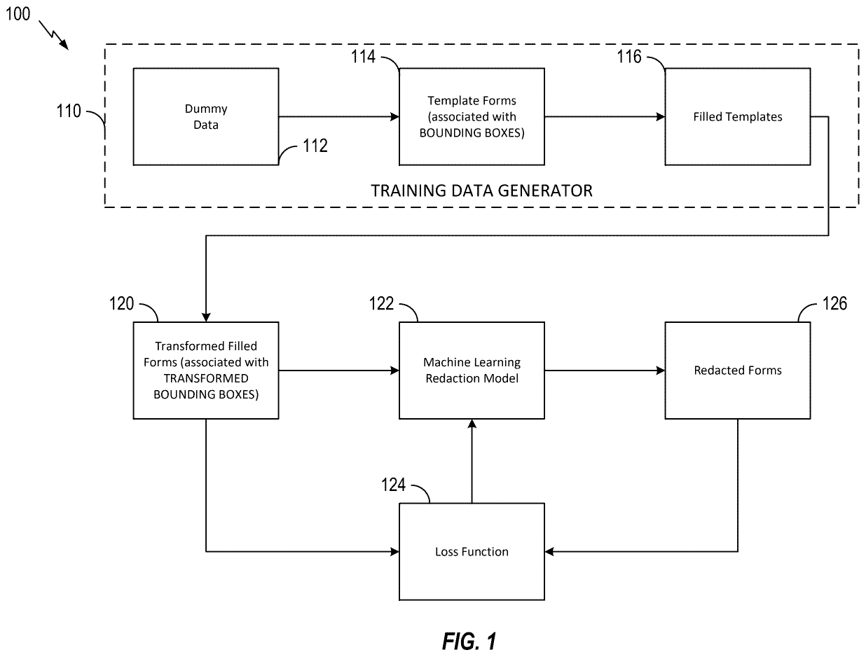

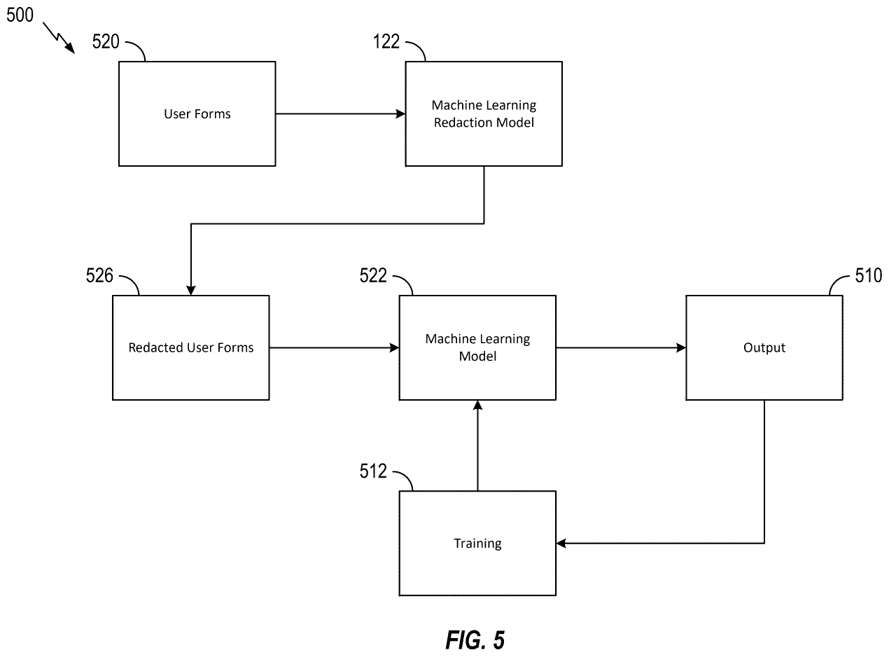

FIG. 1 depicts a training system 100 for training a machine learning redaction model 122. The system 100 may include a training data generator 110 that may create training data, e.g., one or more transformed filled forms 120, to be provided to the machine learning redaction model 122 for the purpose of learning the task of redacting data (e.g., text) that may be entered on forms, such as user forms 520 as discussed with respect to FIG. 5. As will be discussed in more detail, the output of the machine learning redaction model 122 may be compared to a target output (e.g., the input form, another target output as discussed, etc.) and, based on loss functions, parameters of the machine learning redaction model 122 may be adjusted, or “tuned”, to optimize the ability of the model to recognize and redact text.

As shown in FIG. 1, the training data generator 110 may be configured to generate one or more transformed filled forms 120. In particular, the training data generator 110 may be configured to use dummy data 112 to fill one or more template forms 114 to generate one or more filled templates 116.

In certain aspects, the dummy data 112 may be generated by a known algorithm, e.g., Gretel.ai, and include items that may simulate data known to typically be present on forms, e.g., names, addresses or the other specific information mentioned above. The dummy data 112 may be formatted to simplify the insertion of the dummy data 112 into templates.

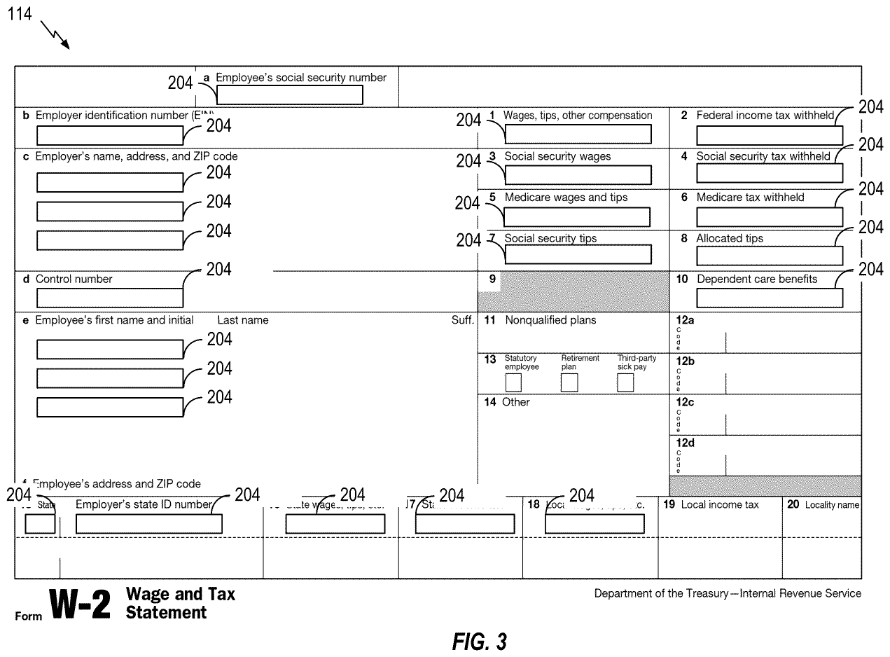

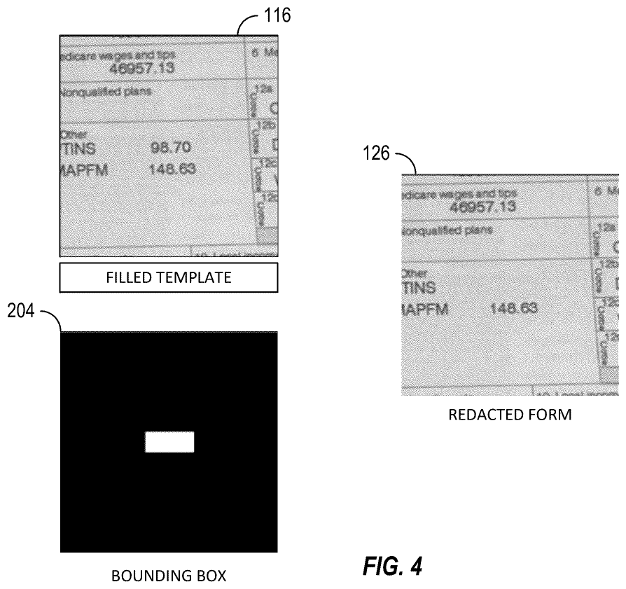

The training data generator 110 may also retrieve one or more template forms 114 from a source, e.g., a public library or Internet resource, where the one or more template forms 114 may be examples of available forms that may include one or more locations, e.g., fields, where an individual can fill in information but which are blank in these locations. One or more bounding boxes 204 may be generated and associated with the locations where text information may be filled in. The one or more bounding boxes 204 may be generated automatically using knowledge of a template form 114 and potential locations for text or alternatively, may be generated manually, e.g., using computer vision techniques or human intervention to determine the areas of the template form 114 that may contain text. As shown in FIG. 3, the one or more bounding boxes 204 may represent a location on a template form 114 where text data may be present, and thus a location that may require redaction by the machine learning redaction model 122. Further, while the one or more bounding boxes 204 may be represented as a graphical box showing an area of the form, the one or more bounding boxes 204 may further be represented as a “cutout,” as shown in FIG. 4, where text in the dark areas may be ignored and thus, only the text in the light area may be redacted by the machine learning redaction model 122.

The training data generator 110 may insert the dummy data 112 in the one or more template forms 114 to create one or more filled templates 116, which may look like actual filled-in forms that could be received by the machine learning redaction model 122, but with dummy data 112 instead of potential PII. The training data generator 110 may or may not use the one or more bounding boxes 204 to guide the insertion of dummy data 112 in the form. As shown in FIG. 4, each of the one or more filled templates 116 may look identical to a corresponding template form 114, except that dummy data 112 has been added to the form.

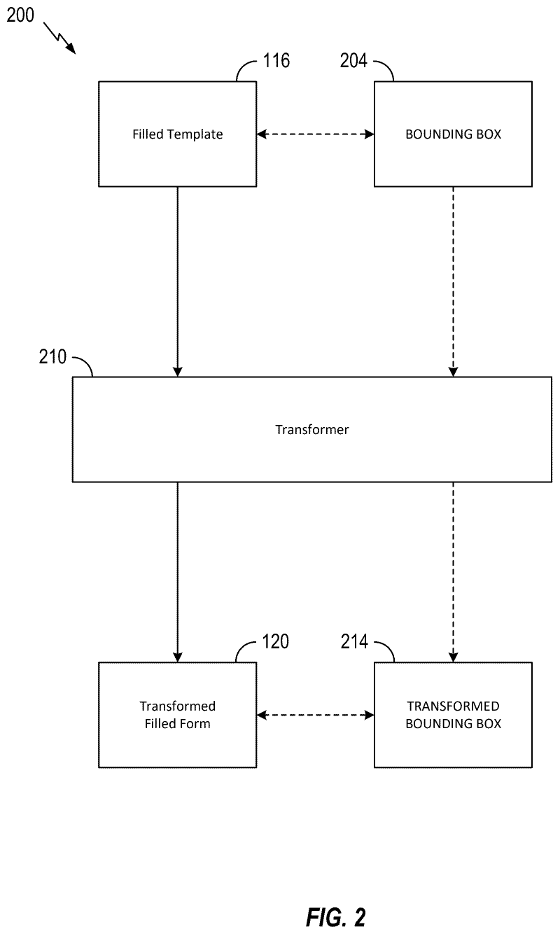

The training data generator 110 may transform the one or more filled templates 116 into one or more transformed filled forms 120 that may be more representative of forms that may be received from end users in practice, e.g., user forms 520 as shown in FIG. 5 below. Transformation of the one or more filled templates 116 and the one or more bounding boxes 204, as discussed and shown in more detail below with respect to FIG. 2, may be used to simulate the various conditions that may be seen in real-world conditions, e.g., by adding a texture to the input or by altering lighting conditions or an orientation of the input. The transformation process may also transform the one or more bounding boxes 204, and generate one or more transformed bounding boxes 214 associated with the one or more transformed filled forms, but is not required to do so.

Each of the one or more transformed filled forms 120, along with each of the one or more associated transformed bounding boxes 214, may be provided to the machine learning redaction model 122 as input, where the machine learning redaction model 122 may produce a redacted user form 126 corresponding to each of the one or more transformed filled forms 120. The system 100 may provide both the input, e.g., a transformed filled form 120, and the corresponding redacted user form 126, to one or more loss functions 124, which may quantify the differences between the two forms. As mentioned above, in certain aspects, the one or more loss functions may include continuity loss, which may indicate a degree to which text redaction may be detected in the form. Once any text has been redacted from a transformed filled form 120 in a location corresponding to the one or more bounding boxes 204 or the one or more transformed bounding boxes 214, the machine learning redaction model 122 may insert a background image in the area defined by an associated bounding box 204 or an associated transformed bounding box 214 to make the redaction less detectable. In certain aspects, a similarity of the background replacement image pixels along the edges of the redacted area to the pixels of the form immediately surrounding the redacted area may be calculated and expressed as the continuity loss. In certain aspects, the one or more loss functions may include a dice score, which in certain aspects would measure similarity between the input and output images, or reconstruction loss, which in certain aspects would calculate a score based on a pixel-by-pixel comparison of the input and output images and thus may account for the one or more bounding boxes 204 or the one or more transformed bounding boxes 214 more accurately than the dice score.

The machine learning redaction model 122 may use the results of the one or more loss functions 124, along with the corresponding transformed filled form 120 and redacted user form 126, to adjust its parameters for the purpose of optimizing the redaction of text by the model.

In certain aspects, the machine learning redaction model 122 may be implemented as a generative adversarial network (GAN), which is a machine learning architecture that trains two machine learning models, known as a “generator” and a “discriminator,” to compete against each other with the goal of generating more authentic new data from a given training dataset. The generator network may generate new data by taking an input data sample and modifying it as much as possible, while the discriminator network would try to predict whether the generated data output belongs in the training dataset, or in other words, predict whether the generated data is fake or real. In a typical GAN architecture, the generator network attempts to maximize the probability of mistake by the discriminator network, while at the same time, the discriminator network attempts to minimize the probability of error. As the training process continues, the two networks should evolve and confront each other continuously until they reach an equilibrium state, at which point the discriminator network can no longer distinguish the generated data from the training dataset and the training process would end.

In machine learning redaction model 122, the generator network may be represented by the redaction of text, and thus the generation of redacted user forms, as previously described. The loss function 124, e.g., the determination of continuity loss or reconstruction loss or dice score, etc., in comparing the redacted user form 126 to a corresponding target output (e.g., transformed filled form 120, transformed unfilled form, etc.), may be used as the discriminator network for machine learning redaction model 122. For example, a customizable, predetermined level of loss may be used to indicate that adjustments are needed to the parameters of the machine learning redaction model 122 to improve the performance of the generator network, or improve the redaction of text. This indication may cause a second pass of the transformed filled form 120 through machine learning redaction model 122, resulting in the generation of a second redacted user form 126 using adjusted model parameters, and also a second pass through the loss function 124, which may compare the second redacted user form 126 to the corresponding target output and indicate whether further passes are needed. By iteratively generating a redacted user form 126 and comparing the redacted user form 126 to the corresponding target output using loss function 124, the training of machine learning redaction model 122 may continue until the equilibrium state has been reached, e.g., the loss function 124 no longer indicates that further generation of a redacted user form 126 is needed. The same iterative training process may be used for each transformed filled form 120 in the training dataset.

One of ordinary skill in the art would recognize that the training process may be further optimized using techniques such as early stopping, where the training process may be stopped before all possible transformed filled forms 120 and other training data is processed to prevent degradation of the machine learning redaction model 122, or, in a GAN embodiment, adding smoothing Gaussian noise to the discriminator to increase the likelihood of distinguishing a transformed filled form 120 from the companion controlled dataset.

Though FIG. 1 depicts each of template form 114, filled template 116, transformed filled form 120, and redacted user form 126 as single entities for ease of illustration, certain aspects may include more template forms 114, filled templates 116, transformed filled forms 120, and redacted user forms 126 as needed in the system 100. Similarly, though FIG. 1 depicts a single loss function 124 for machine learning redaction model 122, the loss function 124 may also be embodied as multiple loss functions 124, e.g., continuity loss and dice score, and the machine learning redaction model 122 may use various combinations of the one or more loss functions 124 as needed in system 100.

### Example System for Transforming Filled Forms

FIG. 2 depicts an example system 200 for transforming a filled template 116 into a transformed filled form 120 for use in training the machine learning redaction model 122. The example system 200 may include a transformer 210 that may modify the appearance of the filled template 116 to more accurately represent the condition of forms, e.g., user forms 520, that may be received by the machine learning redaction model 122. As will be discussed in more detail, characteristics such as texture, lighting and orientation may be added or modified with respect to the filled template 116 to create a transformed filled form 120. The transformer 210 may, but is not required to, transform the one or more bounding boxes 204 into the one or more transformed bounding boxes 214 in a related manner.

As shown in FIG. 2, the transformer 210 may be implemented as part of the example system 200 to create one or more transformed filled forms 120 and, optionally, one or more transformed bounding boxes 214.

In certain aspects, the filled template 116 may be received by the transformer 210 as a result of the process described in FIG. 1 for filling a template form 114 with dummy data 112 or, alternatively, a filled template 116 may be received directly from an external source, e.g., a public library or Internet resource. The one or more bounding boxes 204 that may be generated and associated with the locations on the form, as described with respect to FIG. 1, may also be received by the transformer 210, though it should be noted that the one or more bounding boxes 204 may be generated and associated with text locations within example system 200 at any point in the training process, including example system 200.

In certain aspects, the transformer 210 may modify characteristics of the filled template 116 to more accurately represent the condition of filled forms that may be received directly from customers in the course of providing services, e.g., user forms 520. These characteristics may include, but are not limited to, a texture, appearance or lighting, or orientation of the form.

In certain aspects, one or more textural images, e.g., various folds or wrinkles, a color, or a printed pattern such as a watermark, may be retrieved by the transformer 210 such that the texture may be combined with the filled template 116 to create a transformed filled form that may appear to possess the retrieved texture. For example, an image of paper folds may be retrieved and combined with a filled template 116 to make the transformed filled form 120 appear to be wrinkled or folded, with a collateral effect on the text in the transformed filled form 120, e.g., the text may be cut off or modified to account for the wrinkles or folds. It should be noted that multiple textures may be used in combination, with no limit on how the images are combined, to create a transformed filled form 120 and a single filled template 116 may result in multiple transformed filled forms 120 as different combinations for the textural images may be combined with the filled template 116.

In certain aspects, characteristics of the filled template 116 with respect to appearance and orientation may be modified to create more conditions that may represent forms that may be received from public sources, e.g., user forms 520. For example, with respect to form appearance, adjustments may be made to brightness or saturation or hue of the filled template 116 to simulate possible lighting conditions of forms as images may be captured. Other characteristics that may be adjusted may include contrast or sharpness or, with respect to orientation, a filled template 116 may be rotated or skewed, as well as flipped to create a “mirror image.” Such adjustments may further simulate the conditions of the form at the time that an image may be captured. As with texture adjustments described above, it should be noted that one or more of the appearance or orientation adjustments may be made to the filled template 116 in multiple combinations such that a transformed filled form 120 may include only one adjustment or multiple adjustments. Likewise, a single filled template 116 may appear in multiple transformed filled forms 120 as different adjustment combinations may be applied separately to the filled template 116.

Also shown in FIG. 2 are the one or more bounding boxes 204 associated with the one or more filled templates 116 that may outline where text may be redacted by the machine learning redaction model 122. Likewise, FIG. 2 depicts the one or more transformed bounding boxes 214 associated with the transformed filled forms 120. As such, the transformer 210 may transform the one or more bounding boxes 204 along with the filled template 116 to create the one or more transformed bounding boxes 214 but is not required to do so. Alternatively, the one or more bounding boxes 204 may be left unchanged by the transformer 210, such that the one or more bounding boxes serve as the one or more transformed bounding boxes 214, or the one or more bounding boxes 204 may be transformed separately, where possible adjustments may be the same or different from an adjustment made to a corresponding filled template 116 as part of the transformation process.

### Example System for Training a Form Management Model

FIG. 5 depicts an example form management system 500 that may utilize the machine learning redaction model 122 for removing text, e.g., PII, from user forms 520 that may be received as part of providing services to users.

As shown in FIG. 5, the machine learning redaction model 122 may receive one or more user forms 520 as input, where text may be entered that requires redaction before further processing of the one or more user forms 520 by machine learning model 522 in the form management system 500. As mentioned above, the requirement for redaction may include, but is not limited to, removing personally identifying information (PII), which may include demographic information such as a name or address or financial information such as account numbers or specific monetary balances or amounts.

The machine learning redaction model 122, being trained using training system 100, may generate one or more redacted user forms 526, where each of the one or more redacted user forms 526 corresponds with a specific user form 520. The one or more redacted user forms 526 that may be produced by the machine learning redaction model 122 may be used as training input for machine learning model 522, which for example may be trained to manage forms that may be received from end users, extract information from forms, or provide one or more operations or services based on data extracted from forms. Machine learning model 522 may produce an output 510 based on the one or more redacted user forms 526, and a training process 512 of machine learning model 522 may use output 510. The training process 512 may use the one or more redacted user forms 526 and output 510 to train parameters of machine learning model 522 and may rely on a loss function that may be similar or different from the loss functions of the machine learning redaction model 122. It should also be noted that, although FIG. 5 shows the one or more redacted user forms 526 as the sole input to machine learning model 522, this depiction is for convenience and it is not required that training process 512 rely solely on the redacted user forms 526.

### Example Method for Training a Machine Learning Redaction Model

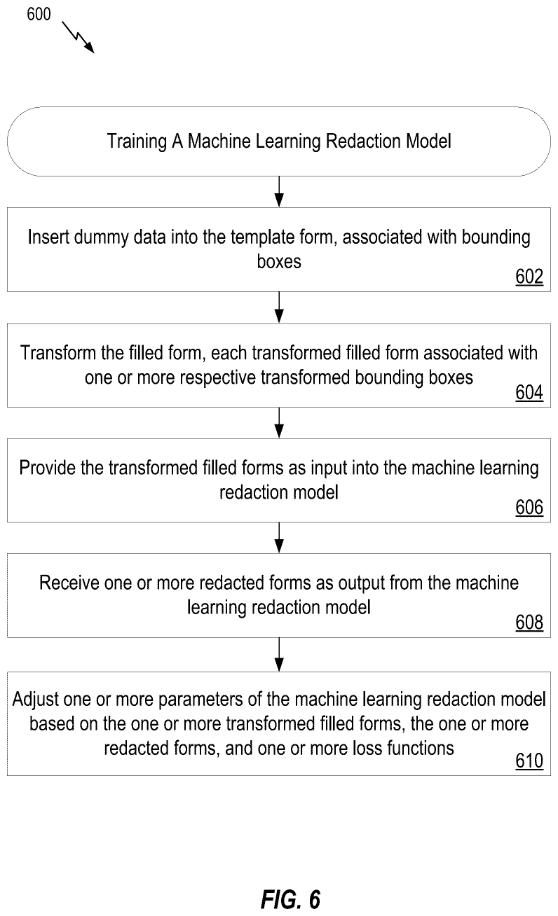

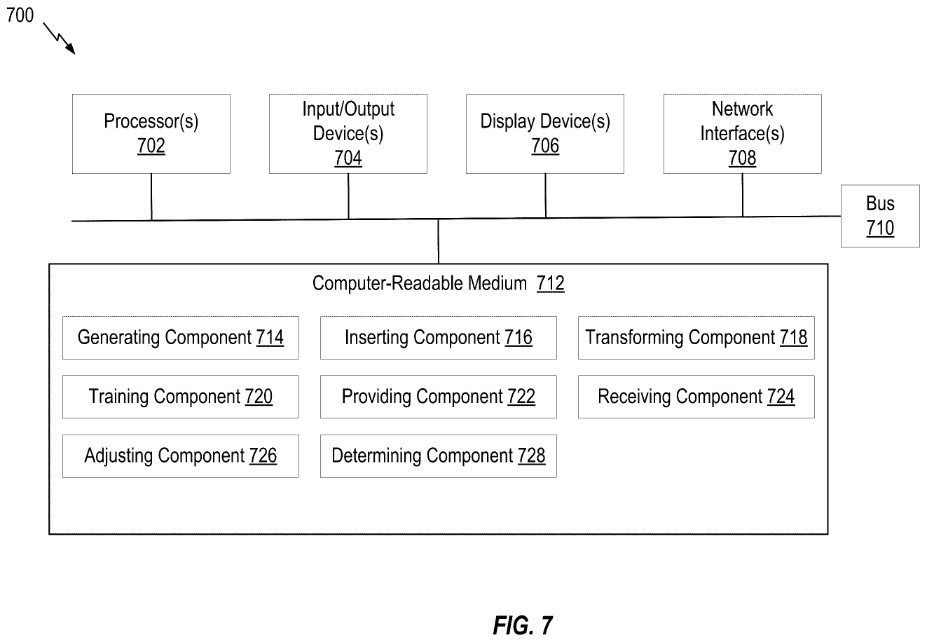

FIG. 6 depicts an example method 600 for training a machine learning redaction model. In one aspect, method 600 can be implemented by the system 100 of FIG. 1 and/or processing system 700 of FIG. 7.

Method 600 starts at block 602 with generating a filled form comprising: inserting dummy data into one or more locations of a template form, wherein the one or more locations are associated with one or more bounding boxes.

Method 600 continues to block 604 with transforming the filled form, associated with the one or more bounding boxes, into one or more transformed filled forms, each of the one or more transformed filled forms associated with one or more respective transformed bounding boxes.

In certain aspects, the method 600 may include training the machine learning redaction model based on the one or more transformed filled forms, the training comprising blocks 606, 608, and 610.

Method 600 continues to block 606 with providing the one or more transformed filled forms as input into the machine learning redaction model.

Method 600 continues to block 608 with receiving one or more redacted forms as output from the machine learning redaction model, based on the one or more transformed filled forms, the one or more redacted forms corresponding to the one or more transformed filled forms.

Method 600 continues to block 610 with adjusting one or more parameters of the machine learning redaction model based on the one or more transformed filled forms, the one or more redacted forms, and one or more loss functions.

In some aspects, method 600 further includes providing one or more user forms as input into the machine learning redaction model.

In some aspects, method 600 further includes receiving one or more redacted user forms as output from the machine learning model, based on the one or more user forms.

In some aspects, method 600 further includes training a second machine learning model based on the one or more redacted user forms.

In some aspects, the one or more user forms comprise PII, and the one or more redacted forms do not include the PII.

In some aspects, the generating the filled form further comprises: determining the one or more locations; and generating the one or more bounding boxes.

In some aspects, method 600 further includes generating a second filled form using a first font.

In some aspects, method 600 further includes transforming the second filled form into one or more second transformed filled forms, wherein: block 602 includes inserting the dummy data using a second font; and the training the machine learning redaction model is further based on the one or more second transformed filled forms.

In some aspects, block 604 includes one or more of: applying a texture to the filled form; rotating the filled form; skewing the filled form; adjusting a brightness of the filled form; adjusting a contrast of the filled form; adjusting a saturation of the filled form; adjusting a sharpness of the filled form; or adjusting an orientation of the filled form.

In some aspects, the filled form comprises the one or more bounding boxes; and block 604 includes transforming the one or more bounding boxes into the one or more respective transformed bounding boxes.

In some aspects, method 600 further includes transforming the one or more bounding boxes into the one or more respective transformed bounding boxes separately from the transforming the filled form.

In some aspects, the machine learning redaction model comprises a GAN.

In some aspects, the one or more loss functions comprise a continuity loss function.

In some aspects, the one or more loss functions further comprise one or more of: a reconstruction loss function or a dice score.

In some aspect, method 600, or any aspect related to it, may be performed by an apparatus or processing system, such as processing system 700 of FIG. 7, which includes various components operable, configured, or adapted to perform the method 600. Processing system 700 is described below in further detail.

Note that FIG. 6 is just one example of a method, and other methods including fewer, additional, or alternative operations are possible consistent with this disclosure.

### Example Processing System for Training a Machine Learning Redaction Model

FIG. 7 depicts an example processing system 700 configured to perform various aspects described herein, including, for example, method 600 as described above with respect to FIG. 6.

Processing system 700 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 700 includes one or more processors 702, one or more input/output devices 704, one or more display devices 706, one or more network interfaces 708 through which processing system 700 is connected to one or more networks (e.g., a local network, an intranet, the Internet, or any other group of processing systems communicatively connected to each other), and computer-readable medium 712. In the depicted example, the aforementioned components are coupled by a bus 710, which may generally be configured for data exchange amongst the components. Bus 710 may be representative of multiple buses, while only one is depicted for simplicity.

Processor(s) 702 are generally configured to retrieve and execute instructions stored in one or more memories, including local memories like computer-readable medium 712, as well as remote memories and data stores. Similarly, processor(s) 702 are configured to store application data residing in local memories like the computer-readable medium 712, as well as remote memories and data stores. More generally, bus 710 is configured to transmit programming instructions and application data among the processor(s) 702, display device(s) 706, network interface(s) 708, and/or computer-readable medium 712. In certain embodiments, processor(s) 702 are representative of a one or more central processing units (CPUs), graphics processing unit (GPUs), tensor processing unit (TPUs), accelerators, and other processing devices.

Input/output device(s) 704 may include any device, mechanism, system, interactive display, and/or various other hardware and software components for communicating information between processing system 700 and a user of processing system 700. For example, input/output device(s) 704 may include input hardware, such as a keyboard, touch screen, button, microphone, speaker, and/or other device for receiving inputs from the user and sending outputs to the user.

Display device(s) 706 may generally include any sort of device configured to display data, information, graphics, user interface elements, and the like to a user. For example, display device(s) 706 may include internal and external displays such as an internal display of a tablet computer or an external display for a server computer or a projector. Display device(s) 706 may further include displays for devices, such as augmented, virtual, and/or extended reality devices. In various embodiments, display device(s) 706 may be configured to display a graphical user interface.

Network interface(s) 708 provides processing system 700 with access to external networks and thereby to external processing systems. Network interface(s) 708 can generally be any hardware and/or software capable of transmitting and/or receiving data via a wired or wireless network connection. Accordingly, network interface(s) 708 can include a communication transceiver for sending and/or receiving any wired and/or wireless communication.

Computer-readable medium 712 may be a volatile memory, such as a random access memory (RAM), or a nonvolatile memory, such as nonvolatile random access memory (NVRAM), or the like. In this example, computer-readable medium 712 includes generating component 714, inserting component 716, transforming component 718, training component 720, providing component 722, receiving component 724, and adjusting component 726, and determining component 728. Processing of the components 714-728 may enable and cause the processing system 700 to perform the method 600 described with respect to FIG. 6, or any aspect related to it

In certain embodiments, generating component 714 is configured to generate a filled form, as described in FIG. 6 with reference to block 602.

In certain embodiments, inserting component 716 is configured to insert dummy data into one or more locations of a template form, wherein the one or more locations are associated with one or more bounding boxes, as described in FIG. 6 with reference to block 602.

In certain embodiments, transforming component 718 is configured to transform the filled form, associated with the one or more bounding boxes, into one or more transformed filled forms, each of the one or more transformed filled forms associated with one or more respective transformed bounding boxes, as described in FIG. 6 with reference to block 604.

In certain embodiments, training component 720 is configured to train the machine learning redaction model based on the one or more transformed filled forms, as described in FIG. 6 with reference to blocks 606, 608, and 610.

In certain embodiments, providing component 722 is configured to provide the one or more transformed filled forms as input into the machine learning redaction model, as described in FIG. 6 with reference to block 606.

In certain embodiments, receiving component 724 is configured to receive one or more redacted forms as output from the machine learning redaction model, based on the one or more transformed filled forms, the one or more redacted forms corresponding to the one or more transformed filled forms, as described in FIG. 6 with reference to block 608.

In certain embodiments, adjusting component 726 is configured to adjust one or more parameters of the machine learning redaction model based on the one or more transformed filled forms, the one or more redacted forms, and one or more loss functions, as described in FIG. 6 with reference to block 610.

Note that FIG. 7 is just one example of a processing system consistent with aspects described herein, and other processing systems having additional, alternative, or fewer components are possible consistent with this disclosure.

### EXAMPLE CLAUSES

Implementation examples are described in the following numbered clauses:

Clause 1: A computer-implemented method for training a machine learning redaction model, the method comprising: generating a filled form comprising: inserting dummy data into one or more locations of a template form, wherein the one or more locations are associated with one or more bounding boxes; transforming the filled form, associated with the one or more bounding boxes, into one or more transformed filled forms, each of the one or more transformed filled forms associated with one or more respective transformed bounding boxes; training the machine learning redaction model based on the one or more transformed filled forms, the training comprising: providing the one or more transformed filled forms as input into the machine learning redaction model; receiving one or more redacted forms as output from the machine learning redaction model, based on the one or more transformed filled forms, the one or more redacted forms corresponding to the one or more transformed filled forms; and adjusting one or more parameters of the machine learning redaction model based on the one or more transformed filled forms, the one or more redacted forms, and one or more loss functions.

Clause 2: The method of Clause 1, further comprising: providing one or more user forms as input into the machine learning redaction model; receiving one or more redacted user forms as output from the machine learning model, based on the one or more user forms; and training a second machine learning model based on the one or more redacted user forms.

Clause 3: The method of Clause 2, wherein the one or more user forms comprise PII, and the one or more redacted forms do not include the PII.

Clause 4: The method of any one of Clauses 1-3, wherein the generating the filled form further comprises: determining the one or more locations; and generating the one or more bounding boxes.

Clause 5: The method of any one of Clauses 1-4, further comprising: generating a second filled form using a first font; and transforming the second filled form into one or more second transformed filled forms, wherein: the inserting the dummy data comprises inserting the dummy data using a second font; and the training the machine learning redaction model is further based on the one or more second transformed filled forms.

Clause 6: The method of any one of Clauses 1-5, wherein the transforming the filled form comprises one or more of: applying a texture to the filled form; rotating the filled form; skewing the filled form; adjusting a brightness of the filled form; adjusting a contrast of the filled form; adjusting a saturation of the filled form; adjusting a sharpness of the filled form; or adjusting an orientation of the filled form.

Clause 7: The method of any one of Clauses 1-6, wherein: the filled form comprises the one or more bounding boxes; and the transforming the filled form comprises transforming the one or more bounding boxes into the one or more respective transformed bounding boxes.

Clause 8: The method of any one of Clauses 1-6, further comprising transforming the one or more bounding boxes into the one or more respective transformed bounding boxes separately from the transforming the filled form.

Clause 9: The method of any one of Clauses 1-8, wherein the machine learning redaction model comprises a GAN.

Clause 10: The method of any one of Clauses 1-9, wherein the one or more loss functions comprise a continuity loss function.

Clause 11: The method of Clause 10, wherein the one or more loss functions further comprise one or more of: a reconstruction loss function or a dice score.

Clause 12: A processing system, comprising: memory comprising computer-executable instructions; and one or more processors configured to execute the computer-executable instructions and cause the processing system to perform a method in accordance with any one of Clauses 1-11.

Clause 13: A processing system, comprising means for performing a method in accordance with any one of Clauses 1-11.

Clause 14: A non-transitory computer-readable medium storing program code for causing a processing system to perform the steps of any one of Clauses 1-11.

Clause 15: A computer program product embodied on a computer-readable storage medium comprising code for performing a method in accordance with any one of Clauses 1-11.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for training a machine learning redaction model, the method comprising:
generating a filled form comprising:
inserting dummy data into one or more locations of a template form, wherein the one or more locations are associated with one or more bounding boxes;
transforming the filled form, associated with the one or more bounding boxes, into one or more transformed filled forms, each of the one or more transformed filled forms associated with one or more respective transformed bounding boxes;
training the machine learning redaction model based on the one or more transformed filled forms, the training comprising:
providing the one or more transformed filled forms as input into the machine learning redaction model;
receiving one or more redacted forms as output from the machine learning redaction model, based on the one or more transformed filled forms, the one or more redacted forms corresponding to the one or more transformed filled forms; and
adjusting one or more parameters of the machine learning redaction model based on the one or more transformed filled forms, the one or more redacted forms, and one or more loss functions.

2. The method of claim 1, further comprising:
providing one or more user forms as input into the machine learning redaction model;
receiving one or more redacted user forms as output from the machine learning redaction model, based on the one or more user forms; and
training a second machine learning model based on the one or more redacted user forms.

3. The method of claim 2, wherein the one or more user forms comprise personal identifying information (PII), and the one or more redacted forms do not include the PII.

4. The method of claim 1, wherein the generating the filled form further comprises:
determining the one or more locations; and
generating the one or more bounding boxes.

5. The method of claim 1, further comprising:
generating a second filled form using a first font; and
transforming the second filled form into one or more second transformed filled forms, wherein:
the inserting the dummy data comprises inserting the dummy data using a second font; and
the training the machine learning redaction model is further based on the one or more second transformed filled forms.

6. The method of claim 1, wherein the transforming the filled form comprises one or more of:
applying a texture to the filled form;
rotating the filled form;
skewing the filled form;
adjusting a brightness of the filled form;
adjusting a contrast of the filled form;
adjusting a saturation of the filled form;
adjusting a sharpness of the filled form; or adjusting an orientation of the filled form.

7. The method of claim 1, wherein:
the filled form comprises the one or more bounding boxes; and
the transforming the filled form comprises transforming the one or more bounding boxes into the one or more respective transformed bounding boxes.

8. The method of claim 1, further comprising transforming the one or more bounding boxes into the one or more respective transformed bounding boxes separately from the transforming the filled form.

9. The method of claim 1, wherein the machine learning redaction model comprises a generative adversarial network (GAN).

10. The method of claim 1, wherein the one or more loss functions comprise a continuity loss function.

11. The method of claim 10, wherein the one or more loss functions further comprise one or more of: a reconstruction loss function or a dice score.

12. A processing system, comprising: memory comprising computer-executable instructions; and one or more processors configured to execute the computer-executable instructions and cause the processing system to:
generate a filled form comprising:
inserting dummy data into one or more locations of a template form, wherein the one or more locations are associated with one or more bounding boxes;
transform the filled form, associated with the one or more bounding boxes, into one or more transformed filled forms, each of the one or more transformed filled forms associated with one or more respective transformed bounding boxes;
train a machine learning redaction model based on the one or more transformed filled forms, wherein to train the machine learning redaction model, the one or more processors are configured to execute the computer-executable instructions and cause the processing system to:
provide the one or more transformed filled forms as input into the machine learning redaction model;
receive one or more redacted forms as output from the machine learning redaction model, based on the one or more transformed filled forms, the one or more redacted forms corresponding to the one or more transformed filled forms; and
adjust one or more parameters of the machine learning redaction model based on the one or more transformed filled forms, the one or more redacted forms, and one or more loss functions.

13. The processing system of claim 12, wherein the one or more processors are configured to execute the computer-executable instructions and cause the processing system to:
provide one or more user forms as input into the machine learning redaction model;
receive one or more redacted user forms as output from the machine learning redaction model, based on the one or more user forms; and
train a second machine learning model based on the one or more redacted user forms.

14. The processing system of claim 12, wherein the one or more processors are configured to execute the computer-executable instructions and cause the processing system to:
generate a second filled form using a first font; and
transform the second filled form into one or more second transformed filled forms, wherein:
to insert the dummy data, the one or more processors are configured to execute the computer-executable instructions and cause the processing system to insert the dummy data using a second font; and
to train the machine learning redaction model is further based on the one or more second transformed filled forms.

15. The processing system of claim 12, wherein to transform the filled form, the one or more processors are configured to execute the computer-executable instructions and cause the processing system to one or more of:
apply a texture to the filled form;
rotate the filled form;
skew the filled form;
adjust a brightness of the filled form;
adjust a contrast of the filled form;
adjust a saturation of the filled form;
adjust a sharpness of the filled form; or
adjust an orientation of the filled form.

16. The processing system of claim 12, wherein:
the filled form comprises the one or more bounding boxes; and
to transform the filled form, the one or more processors are configured to execute the computer-executable instructions and cause the processing system to transform the one or more bounding boxes into the one or more respective transformed bounding boxes.

17. The processing system of claim 12, wherein the one or more processors are configured to execute the computer-executable instructions and cause the processing system to:
transform the one or more bounding boxes into the one or more respective transformed bounding boxes separately from transforming the filled form.

18. The processing system of claim 12, wherein the machine learning redaction model comprises a generative adversarial network (GAN).

19. The processing system of claim 12, wherein the one or more loss functions comprise a continuity loss function.

20. One or more non-transitory computer-readable media comprising executable instructions that, when executed by one or more processors of an apparatus, cause the apparatus to perform operations comprising:
generating a filled form comprising:
inserting dummy data into one or more locations of a template form, wherein the one or more locations are associated with one or more bounding boxes;
transforming the filled form, associated with the one or more bounding boxes, into one or more transformed filled forms, each of the one or more transformed filled forms associated with one or more respective transformed bounding boxes;
training a machine learning redaction model based on the one or more transformed filled forms, the training comprising:
providing the one or more transformed filled forms as input into the machine learning redaction model;
receiving one or more redacted forms as output from the machine learning redaction model, based on the one or more transformed filled forms, the one or more redacted forms corresponding to the one or more transformed filled forms; and
adjusting one or more parameters of the machine learning redaction model based on the one or more transformed filled forms, the one or more redacted forms, and one or more loss functions.
